(19) United States
(12) Patent Application Publication
(10) Pub. No.: US 2005/0132008 A1
(43) Pub. Date: Jun. 16, 2005

(54) Database supported message routing

(75) Inventors: Kyle G. Brown, Apex, NC (US); Keyur D. Dalal, Cary, NC (US); Mark D. Weitzel, Durham, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/732,077

(22) Filed: Dec. 10, 2003

(51) Int. Cl. G06F 15/173; G06F 15/16

(52) U.S. Cl. 709/206; 709/245

(57) ABSTRACT

The present invention is a method, system and apparatus for routing messages in a computing enterprise. In accordance with the present invention, one or more stateless message brokers can be coupled to a database of message routing filters. Subscribers to particular messages in the message routing system can register individual filters in the database which describe which types of messages are to be routed to the subscribers rather than with individual stateful message brokers. When a stateless message broker receives an incoming message, the message broker can formulate a single database query based upon artifact attributes encapsulated within the message and the message broker can forward the query to the database. Using the single query, the database can resolve a set of zero or more subscribers who have registered a filter matching the artifact elements in the query. The resolved set of subscribers can be returned to the stateless message broker which can route the messages accordingly.

### BACKGROUND OF THE INVENTION

1. Statement of the Technical Field

The present invention relates to the field of message routing and more particularly to the parsing of message content to identify subscribers to the message.

2. Description of the Related Art

Message routing relates to the communication of messages between a message source and a message sink in a data communications network. In the prototypical message routing configuration, a message broker can be communicatively coupled both to a multiplicity of messages sources, and a multiplicity of message recipients. Generally, messages originating from the message sources can pass into the message broker before terminating with the message recipients. The message broker can selectively route individual ones of the messages to appropriate ones of the message recipients based upon one or more pre-configured routing instructions. Typically, the pre-configured routing instructions take the form of, “Route all messages of type X to Recipient Y.”

While an ordinary message broker in the most basic of environments can process individually received messages for only a few routing instructions and message recipients, routing a tremendous volume of messages to a significant number of message recipients based upon a substantially even greater number of rules can become problematic. In particular, as individual message brokers in of themselves represent mere computer programs dependent upon access to underlying computing resources, message brokers can be limited in the number of messages and routing operations which can be performed within a given interval. Moreover, as the size of the message system can vary over time, the ability to scale the message system can suffer given the limited flexibility of the conventional message brokers.

The most primitive message broker can be pre-configured according to a set of rules for routing certain message types to certain recipients. In a somewhat more advanced implementation, the message broker can read a separate configuration file to identify routing rules for routing messages to certain recipients. Yet, to truly support the dynamic addition and removal of recipients from the message brokering configuration, a subscription model can be implemented in which message recipients can intelligently access a message brokering interface to register for the receipt of messages matching a certain criteria. While the subscription model as applied to message brokering can overcome several wasteful deficiencies known in the more primitive implementation of a messaging system, the subscription model still lacks an inherent scalability required by the modern enterprise environment.

Today, subscription based message brokering technologies are stateful and incorporate all data required for routing a message or notification to subscribing clients. Specifically, as message documents pass through the message broker, the message broker can match internally disposed rules to the message (typically the message header) to determine a set of appropriate recipients for the message. Of course, while the complete encapsulation of routing rules in the message broker can suffice for a limited set of subscribers, once again, the stateful characteristic of a message broker can inhibit the scaling of the message routing architecture to a substantially larger number of subscribers. More particularly, as each subscription to a particular type of message must be maintained within each message broker in order to route appropriate messages to registered subscribers, the number of subscribers able to be managed by a single message broker can be severely limited by the computing resources available to the message broker.

### SUMMARY OF THE INVENTION

The present invention addresses the deficiencies of the art in respect to message routing in the enterprise environment and provides a novel and non-obvious method, system and apparatus for message routing using stateless message brokers. In accordance with the present invention, a message routing system can include a database storing one or more message routing filters. One or more stateless message brokers can be coupled to the database. Finally, matching logic can be disposed within each of the message brokers and configured to match fragments specified by the filters with data encapsulated within messages in order to identify subscribers for the messages.

The database can include one or more message fragments describing corresponding message artifact attributes and a relational linkage between the fragments and the filters. The database also can include one or more subscribers to the filters and a relational linkage between the subscribers and the filters. The database yet further can include one or more preferred delivery channels associated with corresponding ones of the subscribers. Finally, the matching logic can include a configuration for generating a single database query to match artifact attributes identified in a received message to the fragments specified by the filters.

A message routing method which has been configured in accordance with the present invention can include the steps of receiving a message and parsing the message to identify message data encapsulated in the message. A database can be queried with the message data to identify a set of subscribers to the message. Consequently, the message can be routed to each of the subscribers. Importantly, the querying step can include the step of generating a single database request to identify the set of subscribers to the message.

In this regard, the generating step can include the step of building a database query with filter fragments produced from the message data to match the filter fragments produced from the message data to filter fragments stored in the database and associated with individual ones of the subscribers. More specifically, the querying step can include identifying a source of the message, correlating the source with at least one filter and selecting each fragment associated with each correlated filter. Subsequently, each fragment can be compared to the message data. Finally, if each fragment in the filter matches the message data in the comparing step, a subscriber associated with the filter can be identified.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a message routing system which has been configured in accordance with the inventive arrangements;

FIG. 2 is an object diagram illustrating an exemplary message notification architecture suitable for use in the message routing system illustrated in FIG. 1;

FIG. 3 is a flow chart illustrating a process for registering a new message notification model in the message routing system of FIG. 1;

FIG. 4 is a flow chart illustrating a process for building a database query for extracting a set of subscriber based upon the receipt of a notification message in the message routing system of FIG. 1; and,

FIG. 5 is a flow chart illustrating a process for routing notifications in the system of FIG. 1.

### DETAILED DESCRIPTION OF THE PREFERRED EMBODIMENTS

The present invention is a method, system and apparatus for routing messages in a computing enterprise. In accordance with the present invention, one or more stateless message brokers can be coupled to a database of message routing filters. Subscribers to particular messages in the message routing system can register individual filters in the database which describe which types of messages are to be routed to the subscribers rather than with individual stateful message brokers. When a stateless message broker receives an incoming message, the message broker can formulate a single database query based upon an artifact encapsulated within the message and the message broker can forward the query to the database. Using the single query, the database can resolve a set of zero or more subscribers who have registered a filter matching the artifact in the query. The resolved set of subscribers can be returned to the stateless message broker which can route the messages accordingly.

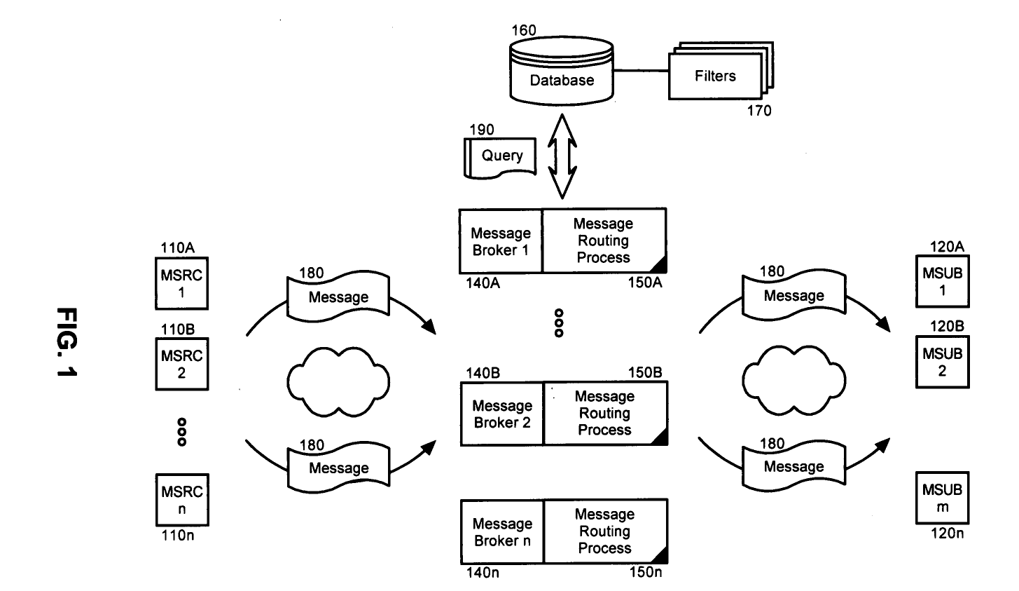

FIG. 1 is a schematic illustration of a message routing system which has been configured in accordance with the inventive arrangements; The system can include one or more message sources 110A, 110B, 110n coupled to one or more message subscribers 120A, 120B, 120n over one or more data communications networks. One or more stateless message brokers 140A, 140B, 140n can be disposed between the sources 110A, 110B, 110n and the subscribers 120A, 120B, 120n and can route messages 180 (otherwise known as “event notifications” or just “notifications”) there between.

Each one of the stateless message brokers 140A, 140B, 140n can be coupled to or can include corresponding message routing logic 150A, 150B, 150n. Additionally, each one of the stateless message brokers 140A, 140B, 140n can be coupled to at least one database 160 configured to store one or more notification filters 170 registered by associated ones of the message subscribers 120A, 120B, 120n. In this regard, individual ones of the message subscribers 120A, 120B, 120n can access the database 160 to register one or more of the filters 170 which can describe notification types which are to be routed to the respective message subscribers 120A, 120B, 120n.

Each of the filters 170 can describe the message types in terms of specific artifacts encapsulated by the messages 180. The artifacts can be located with in the content of the messages 180, within the header information of the messages 180, or both. Each artifact can include a set of attributes. Each attribute, in turn, can include one or more attribute components. As an example, an artifact attribute can include a left hand component, an operator component and a right hand component, When combined, the components can resolve to the attribute and the attributes of an artifact, when combined, can resolve to the artifact.

In operation, when a message (notification) 180 is received in a message broker 140A, 140B, 140n, associated message routing logic 150A, 150B, 150C can parse the message 180 to extract the artifact in the message 180. Once extracted, filter fragments can be produced for the artifact attributes to identify the artifact attributes and the filter fragments can be formulated into a single database query 190 which can include query instructions for identifying a matching filter containing all of the filter fragments corresponding to the attributes in the artifact. The single database query 190 further can include query instructions for identifying all message subscribers' 120A, 120B, 120n whom have registered with the database 160 to receive messages 180 which contain artifacts which match the filter.

Based upon the result of the single query 190, the message routing logic 150A, 150B, 150n can route the message 180 to the identified message subscribers 120A, 120B, 120n. Importantly, as the results of the database query 190 can produce the identity of the message subscribers 120A, 120B, 120n who are to receive the message 180, there is no need to maintain state within the message brokers 140A, 140B, 140n. Accordingly, the system shown in FIG. 1 can enjoy substantial scalability not available in conventional message routing systems as an unlimited number of message brokers can communicate with the database to resolve a set of subscribers to whom messages are to be routed.

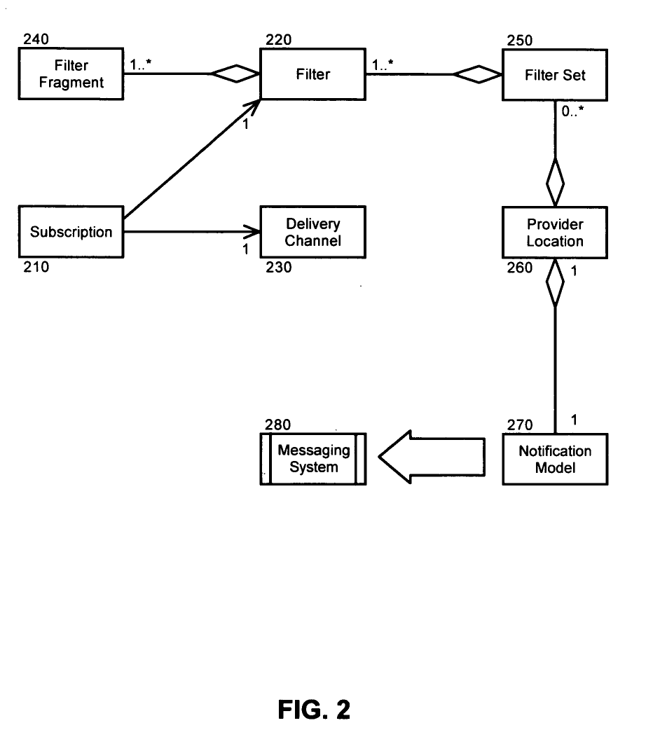

To support the stateless nature of the system of FIG. 1, a message notification architecture can be arranged to describe the relationship between subscribers, filters, filter fragments, sets of filters and message sources. In more particular illustration, FIG. 2 is an object diagram illustrating an exemplary message notification architecture suitable for use in the message routing system illustrated in FIG. 1. As shown in FIG. 2, a message routing system 280 can be configured to interact with a notification model 270. The notification model 270 can describe the structure of notifications received in the message routing system. More particularly, the notification model 270 can describe a format for an artifact within messages which can be processed using the notification model 270.

The notification model 270 can be associated with a source of notifications 260. In this regard, the notification model 270 can be invoked strictly for those notifications emanating from a particular notification source 260. The notification source 260 itself can be associated with zero or more sets of filters 250 which can logically group one or more filters 220 in the set 250. Each filter 220 can uniquely identify a message type which conforms to the format described in the notification model 270, To that end, each filter 220 can be associated with one or more filter fragments 240 which can describe artifact attributes disposed within messages having the message type associated with the filter 220.

Consequently, each filter 220 can reference one or more filter fragments 240 which can be compared to fragments produced based upon identifiable artifacts in a notification. Where all fragments 240 match the fragments produced based upon the identifiable artifacts in a notification, it can be presumed that the notification matches the filter 220. As such a subscriber 210 associated with the filter 220 can be resolved directly in association with the filter 220 and the notification can be routed accordingly. Optionally, a preferred delivery channel 230 also can be associated with the subscriber 210 and can be utilized when selecting a transport method for routing the notification.

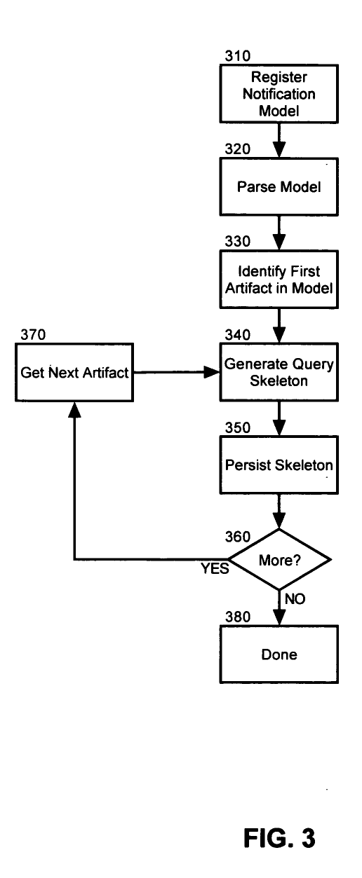

The message subscribers can register to receive the notifications by registering one or more filters in the database. FIG. 3 is a flow chart illustrating a process for registering a new message notification model in the message routing system of FIG. 1; Beginning first in block 310, the subscriber can request the registration of a notification model by specifying a particular model. In block 320, the model can be parsed to identify the individual elements of the model. Specifically, in block 330, a first artifact can be identified. An artifact can represent a type of message which can be processed in the message routing system and can be uniquely described by its attributes.

In block 340, a query skeleton can be generated for the artifact. The query skeleton can include a skeletal database query statement configured to retrieve the identity of a subscriber registered to receive messages having artifact attributes which match the filter fragments described in a corresponding filter. Importantly, the query skeleton can be combined with a dynamic query portion specific to the particular attributes identifiable in a selected message. When combined into a single query statement, the query can be provided to the database which can result in the production of a set of subscribers to the selected message. To facilitate an understanding of the single query statement, Appendix A includes an exemplary query skeleton formulated using structured query language and configured for combination with a dynamic query portion.

In any case, returning now to FIG. 3, the query skeleton can be persisted in fixed storage and optionally in volatile storage such as in a database cache. To the extent that additional artifact can be identified within the model in decision block 360, in block 370 the next artifact subclass can be retrieved and the process can repeat through blocks 340 to 360. When all artifacts in the model have been processed, in block 380 the process can end. Also, once the model has been registered in the database, queries can be executed which can include specified filter fragments which can be matched to the filter fragments in the database to identify a set of subscribers for an associated notification.

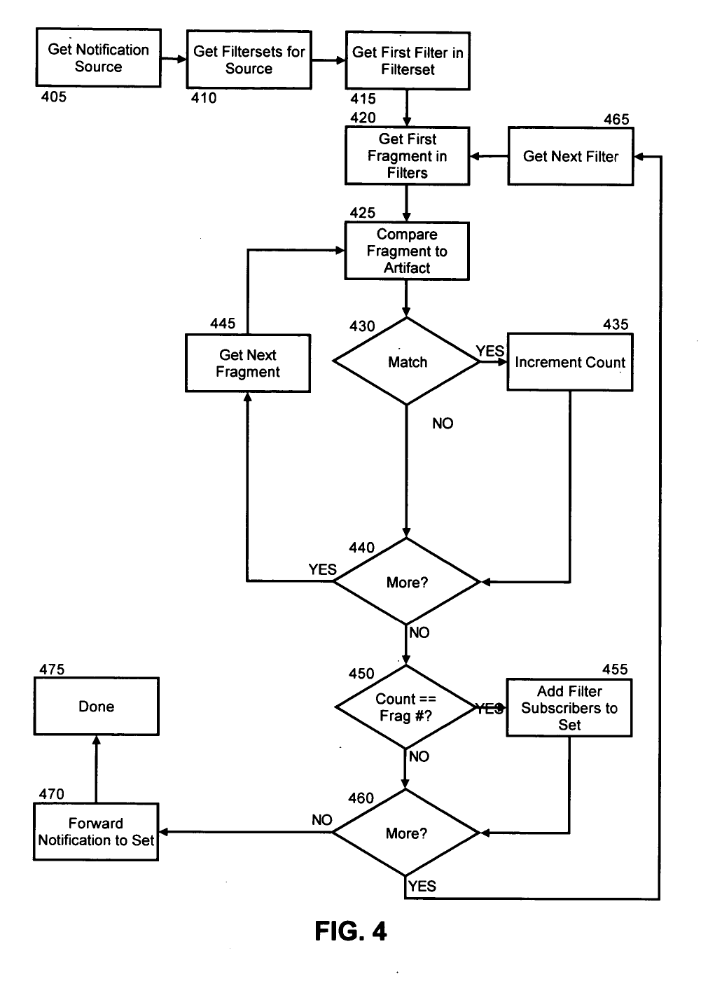

In more particular illustration, FIG. 4 is a flow chart illustrating a process for extracting a set of subscriber based upon the receipt of a notification message in the message routing system of FIG. 1. The process illustrated in FIG. 4 can be performed responsive to a single query constructed to cause the database perform the following steps. Beginning in block 405, a source of the notification can be identified and in block 410, all of the filter sets for the identified source can be retrieved. In block 415, a first filter in the filter set can be selected for analysis and in block 420, the first filter fragment for the first filter can be selected for analysis.

In block 425, the retrieved filter fragment can be compared to the attributes of an artifact specified within the query to determine if a match has occurred. If in decision block 430, a match has occurred, in block 435 a match counter can be incremented and the process can continue in decision block 440. In particular, the process can repeat for the next filter fragment for the selected filter in block 425 through block 445 until all filter fragments for the selected filter have been analyzed. Subsequently, the process can continue in decision block 450.

In decision block 450, if the counter for the selected filter has a value equal to the number of fragments associated with the filter, it can be presumed that the artifact specified within the query matches the filter and in block 455 the subscribers associated with the filter can be added to set of subscribers who are to receive the notification. In either case, in block 460 it can be determined if additional filters are to be processed in the filter set. If so, in block 465 the next filter can be retrieved and the process can continue through blocks 420 through 460. Once all filters in the filter set have been processed, in block 470, the resulting set of subscribers can be returned to the message broker which issued the query and the message broker can route the notification to the subscribers in the set. In block 475, the process can end.

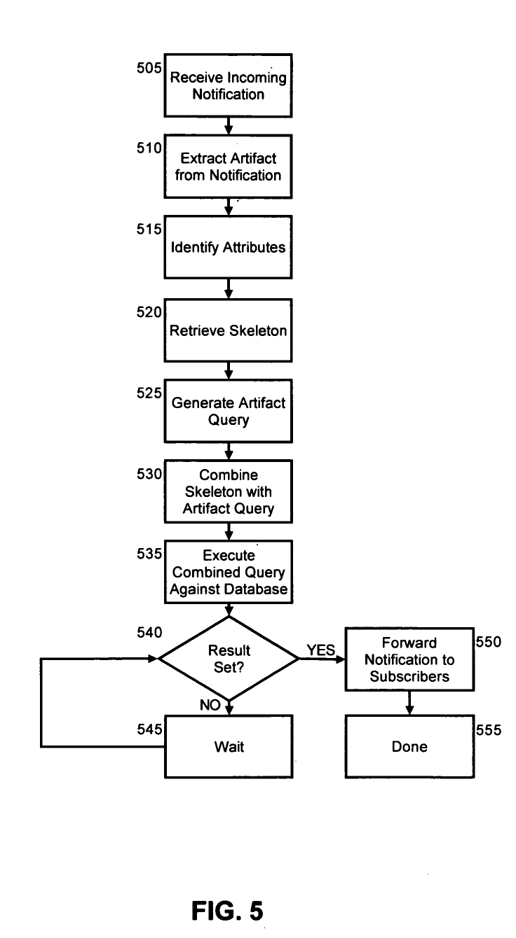

FIG. 5 is a flow chart illustrating a overview of the process for routing notifications in the system of FIG. 1. Beginning in block 505, a notification can be received in the message broker. In block 510, an artifact can be extracted from the notification and in block 515, the attributes of the artifact can be identified. In block 520, a skeleton corresponding to the artifact can be retrieved from persistent storage and in block 525 an artifact query can be generated for the identified attributes. In block 530, the artifact query can be combined with the skeleton to produce a single database query. In block 535, the single query can be issued to the database and in blocks 540 and 545, the message broker can await a response. When a response is received, the response will include a set of subscribers to the notification. Accordingly, in block 550 the notification can be routed to the set of subscribers and the process can end in block 555.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

### Appendix A

The following query is generated for an incoming message where:
$PROVIDER_NAME is the name of the provider that produced this notification.
$ARTIFACT_NAME, $ARTIFACT_DISPLAY_NAME, $CURRENT_ACTION represent values for known attributes of the base model.
$INCOMING_ARTIFACT_FIELDn represents the nth attribute of the artifact type that the message represents.
$INCOMING_ARTIFACT_NAME represents the type name of the incoming Artifact.
1. SELECT*FROM collab.DeliveryChannel as DeliveryChannel
2. WHERE id IN (SELECT deliveryChannel_ID
3. FROM collab.Filter as Filter,
4. collab.Subscription as Subscription,
5. collab.FilterSet as FilterSet,
6. collab.ProviderLocation as ProviderLocation
7. WHERE Subscription.active < >0 AND
8. Filter.id=Subscription.filter_id AND
9. FilterSet.id=Filter.filterset_id AND
10. FilterSet.providerLocation_ID=ProviderLocation.id AND
11. ProviderLocation.name=‘$PROVIDER_NAME’ AND
12. Filter.id IN (SELECT filterID
13. FROM(SELECT filter_ID AS filterID, COUNT(id) as count
14. FROM collab.FilterFragment AS FilterFragment
15. WHERE ((Ivalue=‘com.ibm.notificationframework.notification.Artifact.name’ AND
16. ((op=‘<’ AND ‘$ARTIFACT_NAME’<rvalue) OR
17. (op=‘=’ AND ‘$ARTIFACT_NAME’=rvalue) OR
18. (op=‘>’ AND ‘$ARTIFACT_NAME’>rvalue)))OR
19. (Ivalue=‘com.ibm.notificationframework.notification.Artifact.displayName’ AND
20. ((op=‘<’ AND ‘$ARTIFACT_DISPLAY_NAME’<rvalue) OR
21. (op=‘=’ AND ‘$ARTIFACT_DISPLAY_NAME’=rvalue) OR
22. (op=‘>’ AND ‘$ARTIFACT_DISPLAY_NAME’>rvalue))) OR
23. (Ivalue=‘com.ibm.notificationframework.notification.Artifact.currentAction’ AND
24. ((op=‘<’ AND ‘$CURRENT_ACTION’<rvalue) OR
25. (op=‘=’ AND ‘$CURRENT_ACTION’=rvalue) OR
26. (op=‘>’ AND ‘$CURRENT_ACTION’>rvalue)))OR
27. (Ivalue=‘$INCOMING_ARTIFACT_FIELD1’ AND
28. ((op=‘<’ AND ‘$INCOMING_ARTIFACT_FIELD1_VALUE’<rvalue) OR
29. (op=‘=’ AND ‘$INCOMING_ARTIFACT_FIELD1_VALUE’=rvalue) OR
30. (op=‘>’ AND ‘$INCOMING_ARTIFACT_FIELD1_VALUE’>rvalue)))OR
31. (Ivalue=‘$INCOMING_ARTIFACT_FIELD2’ AND
32. ((op=‘<’ AND ‘$INCOMING_ARTIFACT_FIELD2_VALUE’<rvalue) OR
33. (op=‘=’ AND ‘$INCOMING_ARTIFACT_FIELD2_VALUE’=rvalue) OR
34. (op=‘>’ AND ‘$INCOMING_ARTIFACT_FIELD2_VALUE’>rvalue)))OR
35. (Ivalue=‘$INCOMING_ARTIFACT_FIELD3’ AND
36. ((op=‘<’ AND ‘$INCOMING_ARTIFACT_FIELD3_VALUE’<rvalue) OR
37. (op=‘=’ AND ‘$INCOMING_ARTIFACT_FIELD3_VALUE’=rvalue) OR
38. (op=‘>’ AND ‘$INCOMING_ARTIFACT_FIELD3_VALUE’>rvalue)))OR
39. (Ivalue=‘com.ibm.notificationframework.notification.Artifact’ AND op=‘=’ AND rvalue=‘*’) OR
40. (Ivalue=‘$INCOMING_ARTIFACT_NAME’ AND op=‘=’ AND rvalue=‘*’))
41. GROUP BY filter_ID
42. INTERSECT
43. SELECT id as filterID, fragmentCount as count
44. FROM collab.Filter AS Filter)
45. AS Temp))
Lines 15-40 are generated by parsing the incoming artifact into its attributes and its relationship to the base artifact.
Lines 13-41 result in filters and the number of filter fragements that matched, the intersection of this with the FilterFragment table (lines 43-44) yield perfect matches.
Lines prior to line 13 associate matched filters with the correct destination.

1. A message routing system comprising:
a database storing a plurality of message routing filters;
a plurality of stateless message brokers coupled to said database; and,
matching logic disposed within each said message brokers and configured to match fragments specified by said filters with data encapsulated within messages in order to identify subscribers for said messages.

2. The system of claim 1, wherein said database further comprises a plurality of message fragments describing corresponding message artifact attributes and a relational linkage between said fragments and said filters.

3. The system of claim 1, wherein said database further comprises a plurality of subscribers to said filters and a relational linkage between said subscribers and said filters.

4. The system of claim 3, wherein said database further comprises a plurality of preferred delivery channels associated with corresponding ones of said subscribers.

5. The system of claim 1, wherein said matching logic comprises a configuration for generating a single database query to match artifact attributes identified in a received message to said fragments specified by said filters.

6. A message routing method comprising the steps of:
receiving a message;
parsing said message to identify message data encapsulated in said message;
querying a database with said message data to identify a set of subscribers to said message; and,
routing said message to each of said subscribers.

7. The method of claim 6, wherein said querying step comprises the step of generating a single database request to identify said set of subscribers to said message.

8. The method of claim 7, wherein said generating step comprises the step of building a database query with filter fragments produced from said message data to match said filter fragments produced from said message data to filter fragments stored in said database and associated with individual ones of said subscribers.

9. The method of claim 6, wherein said querying step comprises the steps of:
identifying a source of said message;
correlating said source with at least one filter;
selecting each fragment associated with said at least one filter;
comparing each fragment to said message data; and,
if each fragment in said at least one filter matches said message data in said comparing step, identifying a subscriber associated with said filter.

10. The method of claim 6, wherein said routing step comprises the step of routing said messages to individual ones of said subscribers using corresponding preferred communications channels identified in said database through said database query.

11. The method of claim 7, wherein said querying step comprises the steps of:
assembling an artifact query based artifact attributes disposed in said message; and,
combining said assembled artifact query with a pre-stored skeleton query associated with an artifact for said message, said combination producing said single database request.

12. A messaging routing system configuration method comprising the steps of:
defining a plurality of message filter fragments describing corresponding message artifact attributes;
combining selected ones of said fragments to form a plurality of filters;
establishing a plurality of associations between said defined filters and corresponding subscribers;
storing said message filters and said associations in a database;
configuring at least one stateless message broker for disposal in a communicative path between individual sources of messages and individual subscribers to said messages; and,
communicatively linking said at least one stateless message broker to said database.

13. A machine readable storage having stored thereon a computer program for message routing, the computer program comprising a routine set of instructions for causing the machine to perform the steps of:
receiving a message;
parsing said message to identify message data encapsulated in said message;
querying a database with said message data to identify a set of subscribers to said message; and,
routing said message to each of said subscribers.

14. The machine readable storage of claim 13, wherein said querying step comprises the step of generating a single database request to identify said set of subscribers to said message.

15. The machine readable storage of claim 14, wherein said generating step comprises the step of building a database query with filter fragments produced from said message data to match said filter fragments produced from said message data to filter fragments stored in said database and associated with individual ones of said subscribers.

16. The machine readable storage of claim 13, wherein said querying step comprises the steps of:
identifying a source of said message;
correlating said source with at least one filter;
selecting each fragment associated with said at least one filter;
comparing each fragment to said message data; and,
if each fragment in said at least one filter matches said message data in said comparing step, identifying a subscriber associated with said filter.

17. The machine readable storage of claim 13, wherein said routing step comprises the step of routing said messages to individual ones of said subscribers using corresponding preferred communications channels identified in said database through said database query.

18. The machine readable storage of claim 14, wherein said querying step comprises the steps of:
assembling an artifact query based artifact attributes disposed in said message; and,
combining said assembled artifact query with a pre-stored skeleton query associated with an artifact for said message, said combination producing said single database request.
